(19) United States
(12) Patent Application Publication
(10) Pub. No.: US 2008/0244552 A1
(43) Pub. Date: Oct. 2, 2008

(54) UPGRADING SERVICES ASSOCIATED WITH HIGH AVAILABILITY SYSTEMS

(75) Inventor: Maria Toeroe, Montreal (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 11/691,944

(22) Filed: Mar. 27, 2007

(51) Int. Cl. G06F 9/44

(52) U.S. Cl. 717/168

(57) ABSTRACT

Service upgrade methods and systems for HA applications are described. System level and application level techniques for routing service requests before, during and after service upgrades are illustrated.

### TECHNICAL FIELD

The present invention generally relates to high availability systems (hardware and software) and, more particularly, to upgrading services associated with such high availability systems.

### BACKGROUND

High-availability systems (also known as HA systems) are systems that are implemented primarily for the purpose of improving the availability of services which the systems provide. Availability can be expressed as a percentage of time during which a system or service is “up”. For example, a system designed for 99.999% availability (so called “five nines” availability) refers to a system or service which has a downtime of only about 0.44 minutes/month or 5.26 minutes/year.

High availability systems provide for a designed level of availability by employing redundant nodes, which are used to provide service when system components fail. For example, if a server running a particular application crashes, an HA system will detect the crash and restart the application on another, redundant node. Various redundancy models can be used in HA systems. For example, an N+1 redundancy model provides a single extra node (associated with a number of primary nodes) that is brought online to take over the role of a node which has failed. However, in situations where a single HA system is managing many services, a single dedicated node for handling failures may not provide sufficient redundancy. In such situations, an N+M redundancy model, for example, can be used wherein more than one (M) standby nodes are included and available.

As HA systems become more commonplace for the support of important services such file sharing, internet customer portals, databases and the like, it has become desirable to provide standardized models and methodologies for the design of such systems. For example, the Service Availability Forum (SAF) has standardized application interface services (AIS) to aid in the development of portable, highly available applications. As shown in the conceptual architecture stack of FIG. 1, the AIS 10 is intended to provide a standardized interface between the HA applications 14 and the HA middleware 16, thereby making them independent of one another. As described below, each set of AIS functionality is associated with an operating system 20 and a hardware platform 22. The reader interested in more information relating to the AIS standard specification is referred to Application Interface Specifications (AIS), Version B.03.01, which is available at www.saforum.org.

Included in these standards specifications is the specification for an Availability Management Framework (AMF) which is a software entity defined within the AIS specification. According to the AIS specification, the AMF is a standardized mechanism for providing service availability by coordinating redundant resources within a cluster to deliver a system with no single point of failure. One interesting feature of the AMF specification is that it logically separates the service provider entities (e.g., hardware and software) from the workload, i.e., the service itself. This feature of HA systems means that the service becomes independent of the hardware/software which supports the service and it can, therefore, be switched around between service provider entities based on their readiness state. This separation characteristic between a service and the entities which support that service also provides a transparency from a user's perspective as the user can identify a requested service simply by naming the service without listing all of the service's associated parameters or features. In this context, a “user” may be many different types of entities including a software and/or hardware application, a person, a system, etc., that uses a particular service.

On the other hand, the logical separation between a service and the entities which support that service in HA systems also creates some challenges. For example, it is not clear in the AIS specification how to perform a seamless service upgrade when the set of attributes associated with a service changes. A service upgrade can be considered to be seamless if, for example, (1) a user whose request arrived before the upgrade started perceives the service according to the old features while a new user (whose request arrives after the upgrade is completed) perceives it according to the new features and (2) a request that arrives during the upgrade is served. In this latter category, the request may be served either with the service's old features or with its new features, however the features of such a service should remain the same till the request is completed. Seamlessness of service upgrades is particularly important for highly or continuously available services because, for services requiring less availability, the service can be instead be terminated and restarted with the new features after the upgrade is performed.

Accordingly, it would be desirable to provide methods, devices and systems for performing service upgrades to highly available services.

### SUMMARY

According to one exemplary embodiment, a method for upgrading a service and providing continuity to ongoing requests for the service while performing the upgrade includes the steps of: supporting a service, wherein the service is logically independent of one or more processing entities which support the service, further wherein an identifier is used to request the service, the identifier being independent of a feature set associated with the service, upgrading the service to modify a first feature set to a second feature set different from the first feature set, receiving a request for the service including the identifier, routing the request either to a first processing entity which supports the service with the first set of features, or to a second processing entity which supports the service with the second set of features different than the first set of features, and terminating the first processing entity's support of the service.

According to another exemplary embodiment, a platform for supporting a service includes a first processing entity for supporting the service with a first set of features, a second processing entity which supports the service which has been upgraded to a second set of features different than the first set of features, and a routing mechanism for routing a request for the service to either the first processing entity or the second processing entity depending upon when the request is received, wherein the service is logically independent of the first and second processing entities, and further wherein the request is independent of the first and second sets of features.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 illustrates a conceptual architecture stack associated with application interface services (AIS);

FIG. 2 depicts a distributed platform management according to an exemplary embodiment;

FIG. 3 shows routing of service requests to service units which support different versions of a service according to an exemplary embodiment;

FIGS. 4(a)-4(c) show exemplary lists or tables which can be used to perform system level routing according to an exemplary embodiment;

FIGS. 5-8 are flowcharts illustrating methods of upgrading services according to various exemplary embodiments;

FIGS. 9(a) and 9(b) illustrate service unit groupings associated with application level routing according to an exemplary embodiment; and

FIG. 10 illustrates hardware and computer-readable media according to exemplary embodiments.

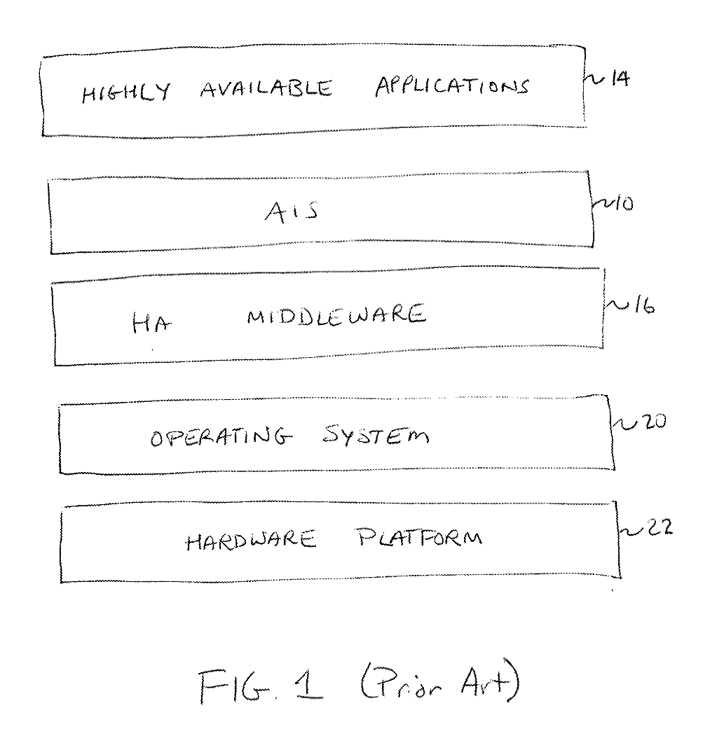

### DETAILED DESCRIPTION

The following description of the exemplary embodiments of the present invention refers to the accompanying drawings. The same reference numbers in different drawings identify the same or similar elements. The following detailed description does not limit the invention. Instead, the scope of the invention is defined by the appended claims.

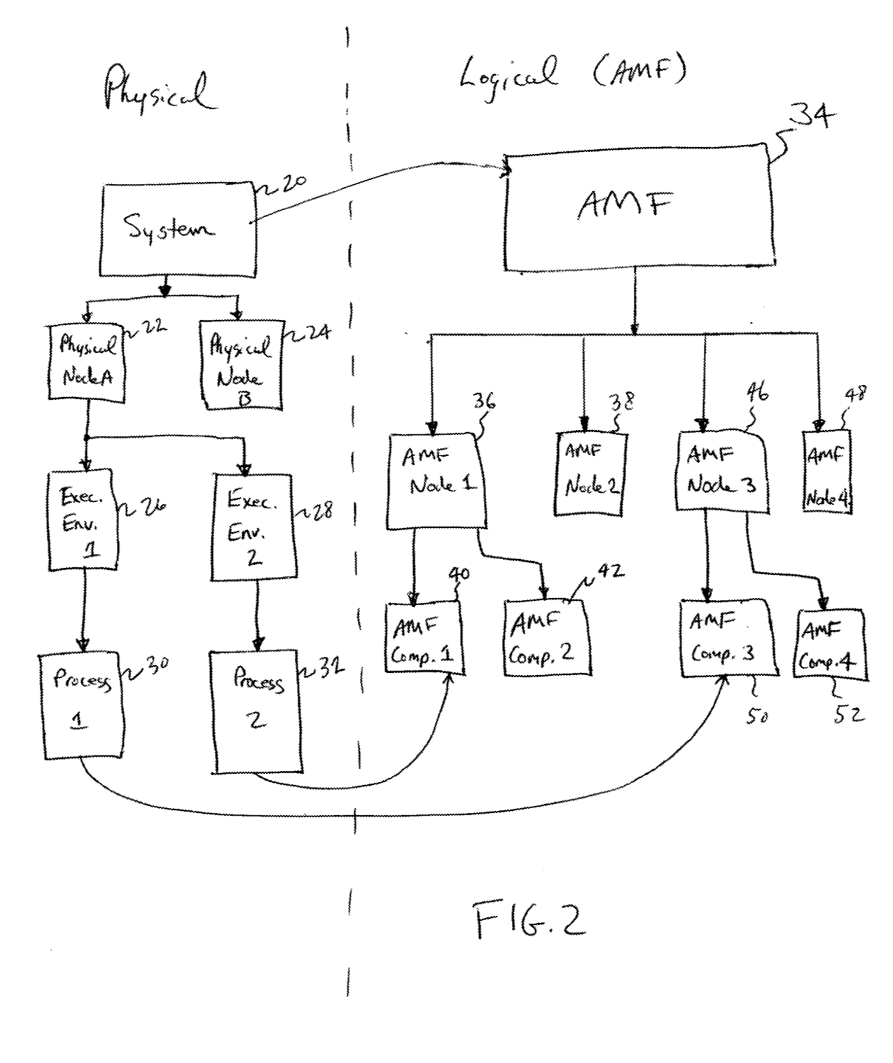

To provide some context for this discussion, in FIG. 2 a physical representation of an exemplary system being supported for high availability is illustrated on the left-hand side of the figure, while a logical representation of the associated distributed AMF portions used to provide this support is illustrated on the right-hand side. Starting on the left-hand side, a system 20, e.g., a server system, can include multiple physical nodes, in this example physical node A 22 and physical node B 24. As one purely illustrative example, the physical nodes A and B can be processor cores associated with system 20. The physical node A 22 has two different execution environments (e.g., operating system instances) 26 and 28 associated therewith. Each execution environment 26 and 28 manages and implements its own process 30 and 32, respectively. Physical node B 24 could have a similar set of execution environments and processes which are not illustrated here to simplify the figure.

The AMF software entity which supports availability of the system 20 and its components 22-32 according to this exemplary embodiment is illustrated logically on the left-hand side of FIG. 2. Each AMF (software entity) can also include a number of cluster nodes and components as shown in FIG. 2. For example, an AMF entity 34 can, for example, manage four AMF nodes 36, 38, 46, 48 and a plurality of AMF components, only four of which (40, 42, 50 and 52) are shown to simplify the figure. It will be appreciated that, although not shown in FIG. 2, AMF Nodes 38 and 48 can also support one or more components. In a physical sense, components are realized as processes of an HA application, e.g., AMF component 40 is realized as process 31 and AMF component 50 is realized as process 30. The nodes 36, 38, 46, 48 each represent a logical entity which corresponds to a physical node on which respective processes managed as AMF components are being run, as well as the redundancy elements allocated to managing those nodes' availability.

As mentioned above, it is desirable to provide techniques and systems for upgrading services being supplied by HA systems such as the exemplary HA system described above with respect to FIG. 2. Initially, it should be understood that requests for services provided by such HA systems are communicated by providing only an identifier, e.g., a logical name, associated with the requested service. Such requests do not include other parameters, e.g., a list of features or parameters associated with the service. Thus, the system 20 (and AMF entity 34) cannot distinguish between a service request for an “old” (pre-upgrade) version of a service and a service request for a “new” (post-upgrade) version of the service. One solution for providing seamless service upgrades to such HA systems is to transfer the state of the ongoing requests to the new service; however this solution requires that the unit servicing the new features also can support the old features while maintaining consistency. This solution may not be feasible for all applications and services.

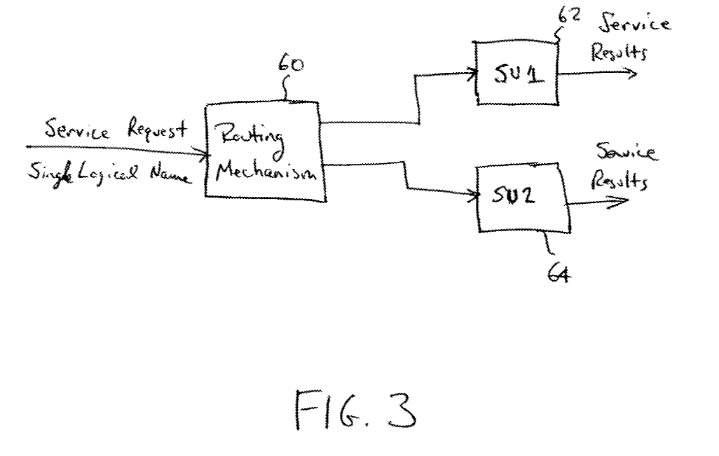

Accordingly, another solution is the introduction of a second level of mapping such that user requests with the same service name are mapped into one of two, different logical names, i.e., one for the old features—the old service—and one for the new features—the new service. This mapping process is illustrated at a high level in FIG. 3. Therein, exemplary embodiments provide for routing 60 a service request either to a first service unit (SU1) 62 which supports the “old” (pre-upgrade) version of a service or to a second service unit (SU2) 64 which supports the “new” (post-upgrade) version of that same service. As will be described in more detail below, upgrading systems and techniques according to these exemplary embodiments can involve, at different time instants, any number of service units which operate to support either (or both) of the new service and the old service. The mapping from the single logical name used in the service request into a routing to one of a plurality of service units can be performed at either a system level, e.g., via the AMF entity 34 in FIG. 2, or at an application level, e.g., via the AMF components associated with the application process being upgraded. Each of these different mapping solutions will now be discussed in detail below according to exemplary embodiments.

### System Level Mapping

Considering first of all exemplary embodiments wherein this mapping is performed at a system level, it should first be appreciated that components, e.g., 40, 42, 50, and 52, and their corresponding service units which are managed for availability purposes by, e.g., AMF entity 34, will generally have, for example, one of four states: active, standby, quiescing and quiesced. An active service unit is one which is servicing incoming requests for a given service instance. Alternatively, a service unit is in the standby state for a service instance if it is ready to continue to provide the service in case of the failure of the active unit. Typically, a standby service unit synchronizes its state for a particular service instance with the active service unit on a regular basis. When a service unit is to be shutdown, e.g., after a service upgrade has been performed, that unit will enter the quiescing state. A formerly active service unit is put into the quiescing state where it continues to serve ongoing requests but will not accept new requests. When a quiescing unit has completed all of its ongoing assignments, that unit is then assigned to the quiesced state. The quiesced state can also be used as an intermediate state when the active and the standby roles need to be switched to avoid multiple simultaneous active assignments. That is, the active unit is put into the quiesced state to force it to prepare for the switch over. Then the standby unit is assigned to the active state and the former active unit can be switched to become the standby unit.

Service units may only be able to enter a subset of these states depending upon the particular redundancy model employed. Exemplary redundancy models include 2N redundancy, N+M redundancy, N-way redundancy and N-way active redundancy, each of which will now briefly be described. For 2N redundancy, one service unit (SU) is assigned in the active role and one in the standby role for each protected service. The service state is regularly synchronized between the two units so that when the active SU fails, the active assignment is switched over to the standby SU which continues to provide the service instance. For N+M redundancy there is one active service unit and there is one standby service unit for each protected service. The standby assignments are collocated on a set of standby service units, the number of which is normally less than the number of active units. When an active SU fails, the standby for its service instance becomes active. The standby assignments of this overtaking unit are either dropped (N+1) or, if there are other standby units, then those assignments are transferred to them.

N-way redundancy provides for one active and N ranked standby assignments for each protected service. An SU may have both active and standby assignments at the same time for different service instances. When a service unit fails all of its active service assignments are switched over to their highest ranking standby SUs. Lastly, N-way active redundancy provides for N service units having the active assignment which typically share the load for the protected service instance. There are no standby assignments in systems employing N-way active redundancy models. Since there are no standby assignments, the continuity of the service instance for a given ongoing request after failure depends on whether the remaining units are prepared to pick up the state of the failed service unit via check-pointing, for example. However, all new requests will still be served after failure in an N-way active redundancy system, albeit with the smaller number of service units.

System level mapping and routing of service requests according to these exemplary embodiments can be performed within a group of service units participating in a redundancy model which are associated with a given service instance from the system's perspective. The most straightforward redundancy model for describing service upgrades having system level redirection of service requests is the N-way active model, since this model permits more than one active service unit assignment per service instance. However the present invention is not limited to application in HA systems employing N-way active redundancy models and can be applied to the other redundancy models described above.

More specifically, the service unit(s) which provide the service serving using the old (pre-upgrade) features need to be gracefully shut down (i.e., transitioned from the active state, to the quiescing state and then to the quiesced state) while the service with the new or updated (post-upgrade) features are provided by the (now) active unit(s) within the service instance. To accomplish this, a control mechanism within the AMF software entity is aware of this second level of mapping and knows which version of a service instance is served by each service unit so that it can apply the correct service unit under the different circumstances that may require actions (e.g., failure).

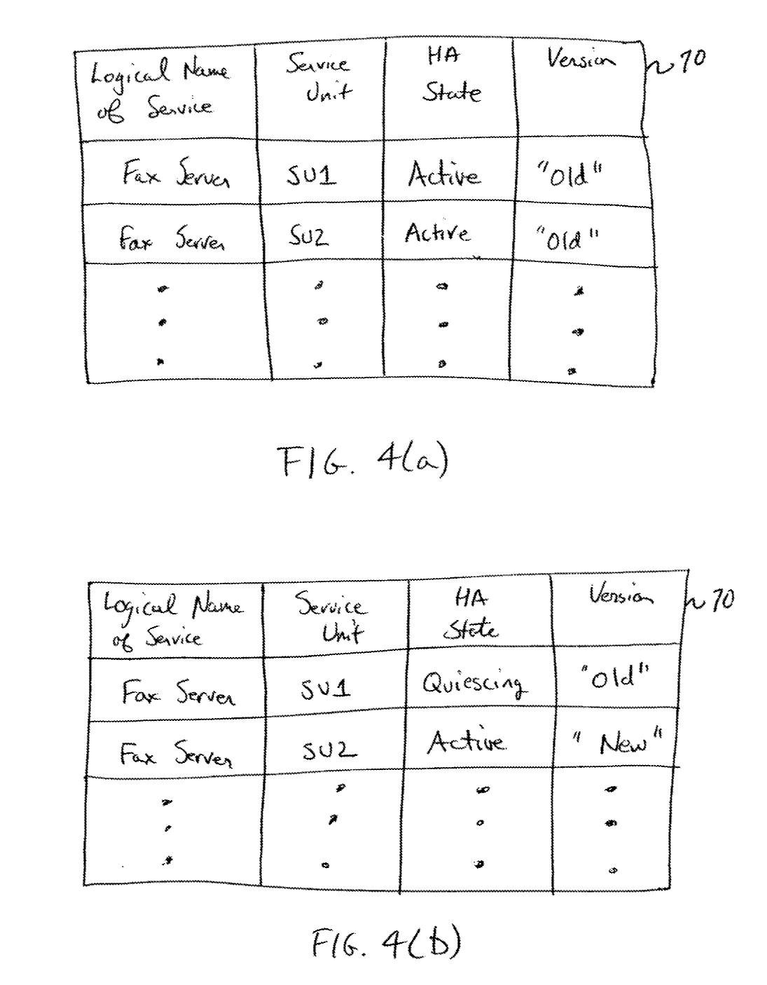

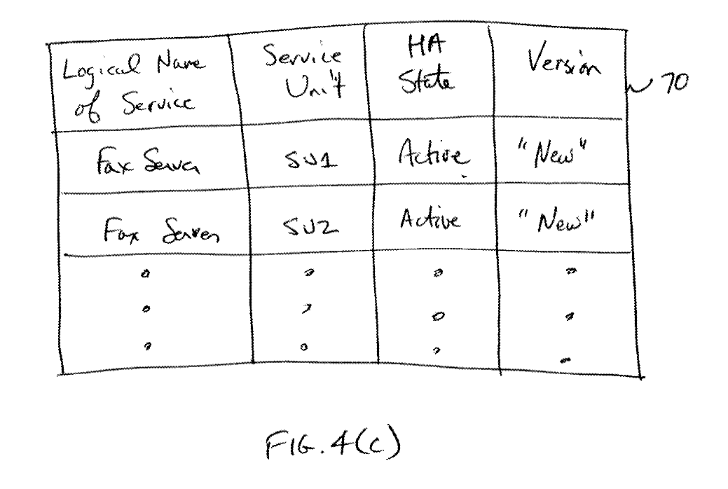

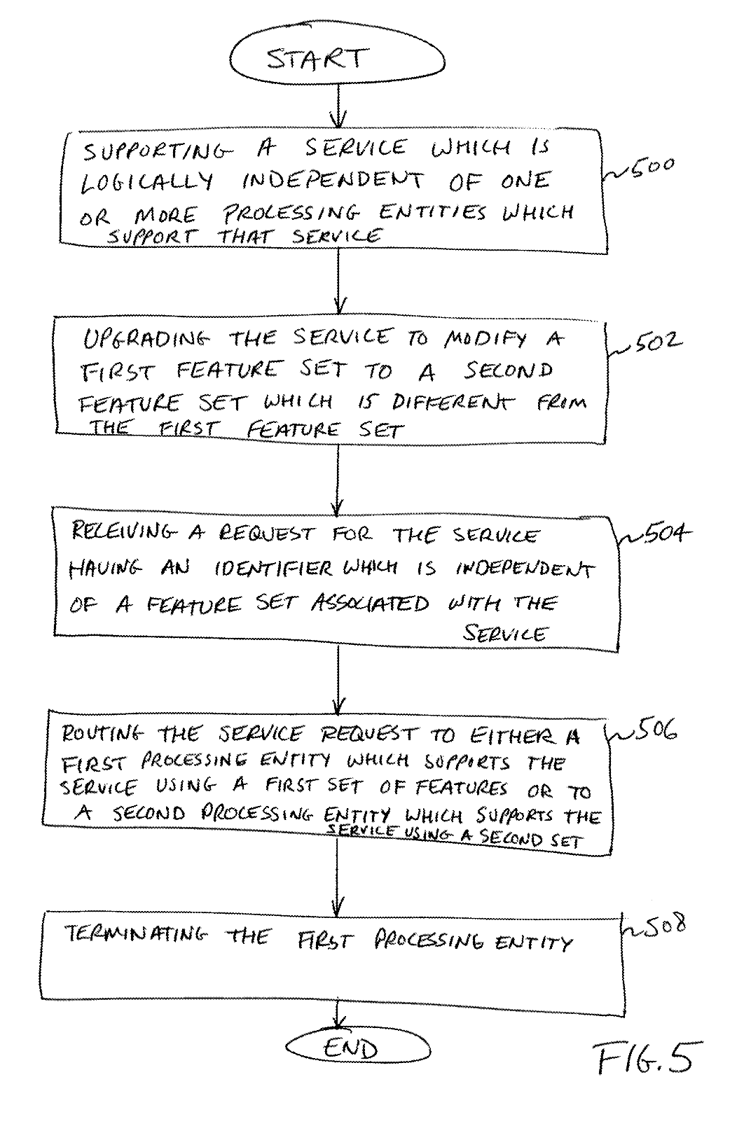

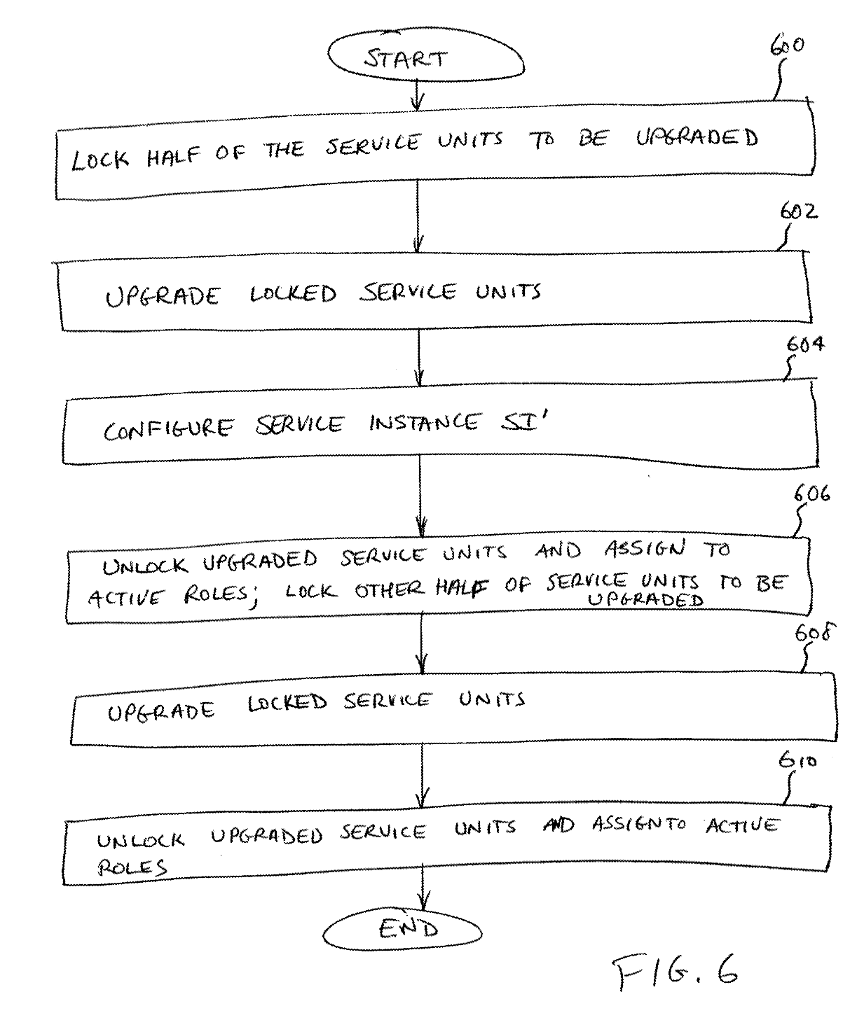

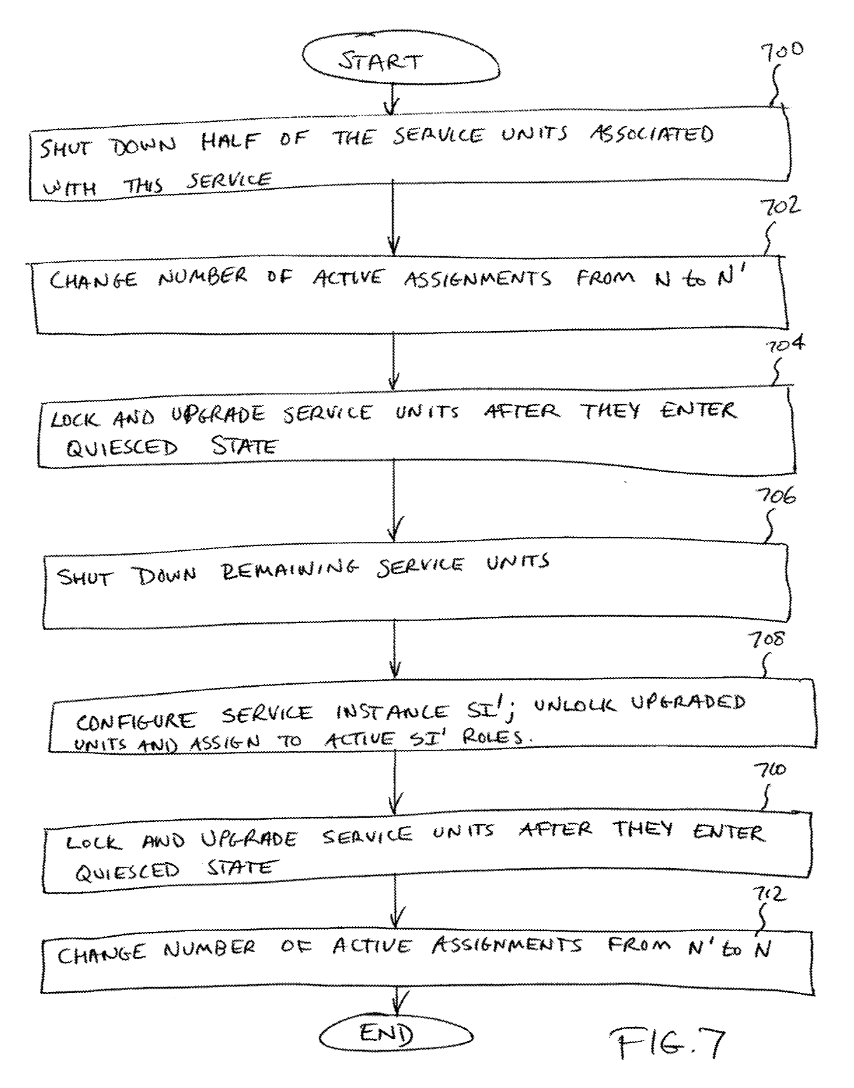

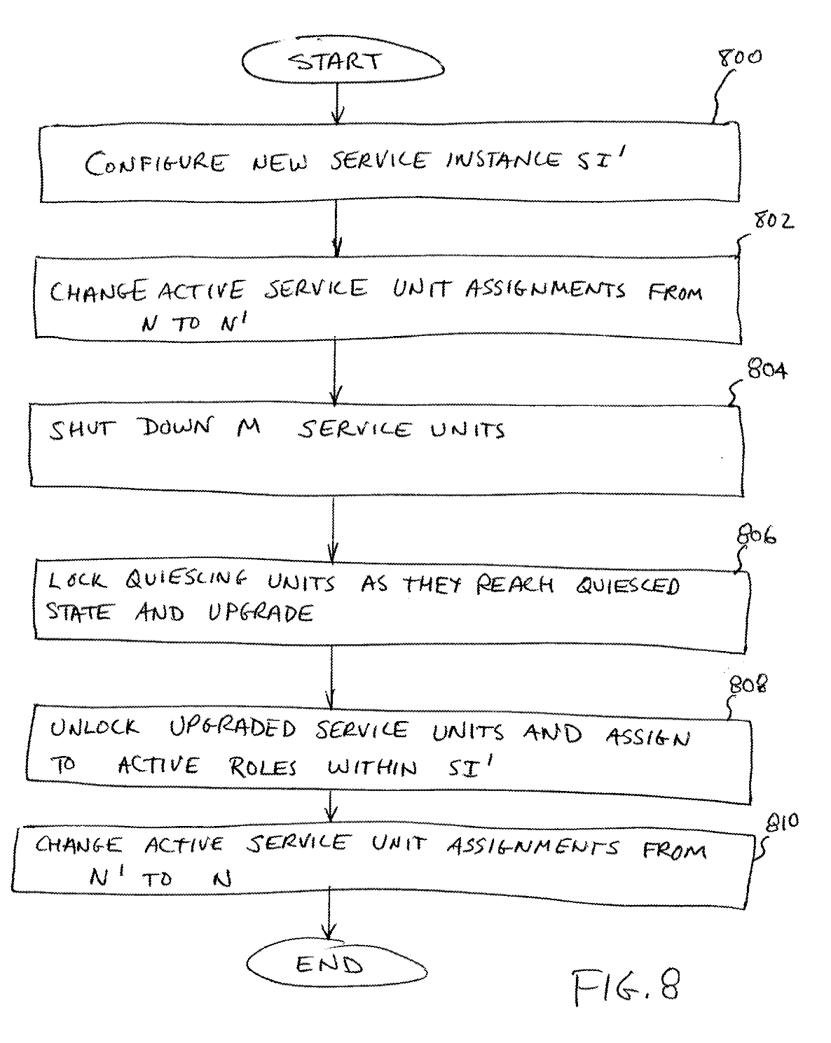

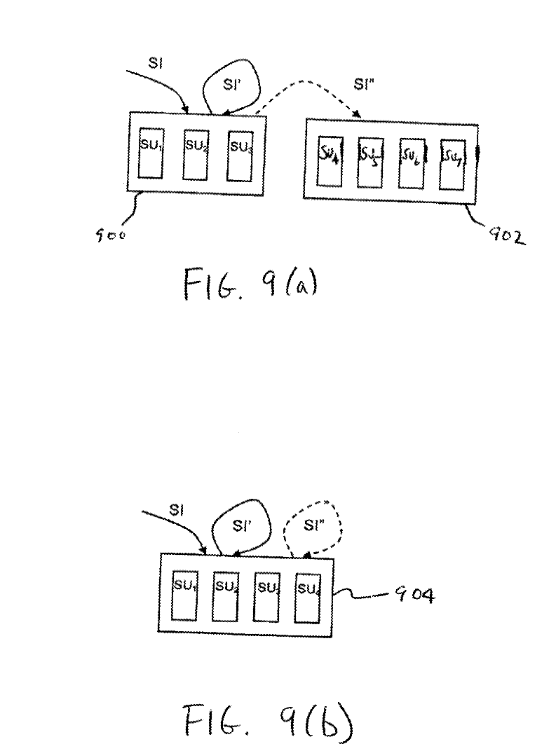

According to exemplary embodiments, this control mechanism within the AMF software entity, e.g., 34, 44, can be implemented as a list or table which is maintained by the AMF software entity. The list or table, a purely illustrative example of which is illustrated as table 70 in FIGS. 4(a)-4(c), can be stored in a memory device (not shown) associated with the hardware which hosts the respective AMF software entity. Therein, it will be seen that the exemplary table 70 includes, for each row, a logical name associated with a requested service, e.g., “Fax Server”, which logical name can be that which is actually received as a service request. For each logical service name, there will be a number of different entries in the table 70—in this example two, although those skilled in the art will appreciate that additional entries could be present depending upon the redundancy model employed and corresponding number of service units associated with each service instance. In the example of FIGS. 4(a)-4(c), each entry includes the logical name of the service, a service unit identifier, an HA state associated with that particular service unit and version information. The version information can be any information which indicates which version of the service is being supported by the service unit associated with that entry in the list or table including, but not limited to, a version number, attribute values associated with the service version or an identifier of a set of features supported.

Each of the tables 70 in FIGS. 4(a), 4(b) and 4(c) show the exemplary table 70 as it is maintained by AMF entity 34 or 44 at different times in the lifecycle of the “Fax Server” service. FIG. 4(a) depicts the table 70 before a service upgrade is performed. Thus, a first service unit SU1 has an HA state of active while a second service unit SU2, which shares the service load for the Fax Server service with service unit SU1, also has a state of active. Both are indicated as supporting the current (“old”) version of the service. Service requests which are received at this time will be routed to either SU1 or SU2.

Moving on to FIG. 4(b), table 70 has been updated by the AMF entity 34 or 44 to reflect that the service is being updated. Thus, service unit SU1 is now in the quiescing state and only handles previously received service requests. If a service request is received at this time, it is routed to service unit SU2 which is now in the active state and supports the new version of the service, as indicated by table 70. As a purely illustrative example, suppose that the “old” service guaranteed delivery of faxes within 10 minutes and the “new” service guarantees delivery of incoming or outgoing faxes within 5 minutes pursuant to a new Service Level Agreement (SLA). The new version of the service may or may not reflect new software and/or hardware associated with the physical process associated with service unit SU2 and its corresponding component.

At some time after the service upgrade has been completed, the exemplary table 70 could be updated again as shown, for example, in FIG. 4(c). Therein, service unit SU1 has become another active service unit for the new version of the service. Service requests are currently being handled by either SU1 and SU2. It will be appreciated that FIGS. 4(a)-4(c) do not necessarily reflect all of the different states of table 70 and that these tables are purely exemplary.

Thus, according to one exemplary embodiment, a method for upgrading a service and providing continuity to ongoing requests for that service while performing the upgrade can include the steps illustrated in the flowchart of FIG. 5. Therein, a service is supported, which service is logically independent of one or more processing entities which support that service at step 500. At step 502, the service is upgraded to modify a first feature set to a second feature set which is different from the first feature set. A request for this service is received at step 504, which request includes an identifier associated with the service, the identifier being independent of a feature set associated with the service. For example, a fax server service request could include the logical name “Fax Server” or “facsimile” but would not include a parameter indicating a five minute or ten minute service guarantee. At step 506, the request is routed to either a first processing entity which supports the service using a first set of features or to a second processing entity which supports the service with a second set of features different than said first set of features. The first processing entity's support of the service can be terminated at step 508, e.g., after all requests have been serviced using the “old” version of the service. Of course it will be appreciated that the steps illustrated in FIG. 5 can be performed in various orders other than the one illustrated therein, e.g., service requests can be received at any given time.

There are various ways in which the redirection of new service requests from quiescing service units to active service units can be performed by AMF entities using, e.g., the list or table 70. For example, a message queue (group) can be created between the appropriate service units by the system, the name of which then is passed to the quiescing service unit as a destination to forward the new requests, while the active service units are instructed to become a receiver of messages of the queue. If there is more than one active unit, then a queue group can be used for which a balancing schema can be defined. Another technique for performing redirection at the system (AMF) level is to rely on the protection group tracking capability of each service unit (at the component level) and instruct the quiescing service units to forward the requests based on this information. In both cases, an appropriate applications programming interface (API) can be used by an AMF entity 34 or 44 to provide a callback to put a service unit into the quiescing state and that unit can inform the AMF entity of the completion of quiescing.

The foregoing exemplary embodiments can be used to provide seamless service upgrades, i.e., guaranteeing continuity of service for ongoing requests. However the present invention is not limited to seamless service upgrades. In cases where seamless service upgrading is not required, a primary consideration is whether there is a need for a software upgrade during the service upgrade.

If no software upgrade is necessary, one solution is to update the service instance from SI to SI′ and apply the change to all of the impacted service units right away by locking and unlocking the service instance. This will interrupt all the ongoing requests and momentarily the service instance will not be available. If, on the other hand, a software upgrade is necessary to upgrade the service, then the switch over to the new version of the service may not be able to be completed quickly. Accordingly, to provide some service during the time of the upgrade, at least some of the service units need to be available. One exemplary procedure for providing some service during a software upgrade is illustrated in the flowchart of FIG. 6. Therein, at step 600, half of the service units associated with the service being upgraded are locked. This action will result in an interruption of the ongoing requests currently being handled by these service units at the time of locking, however some continuity is provided by the remaining, unlocked service units. Next, at step 602, the locked service units are upgraded to the new version of the software so that they become capable of serving the updated service instance SI′.

At step 604, the updated service instance SI′ is configured. At this point, using the foregoing service upgrade of a facsimile server service as an example, the 10 minute service provision associated with SI is changed to 5 minutes associated with SI′. When the actual assignment is made by the AMF 34 to the service units, it passes this time parameter that is configured for the logical name of the service. The upgraded service units are then unlocked at step 606 and assigned to active roles in the updated service instance SI; the remaining service units, i.e., those which were unlocked while the first half of the service units were locked and upgraded are now locked. The locked service units are upgraded at step 608 so that they become capable of serving the updated service instance SI′. Theses service units can then be unlocked at step 610, wherein all of the service units supporting this service will then have been upgraded.

The exemplary table or list 70 illustrated in FIGS. 4(a)-4(c) includes a row of elements which enable the control mechanism associated with AMF entities 34 or 44 to determine which service units are handling which version of a particular service. However, according to other exemplary embodiments, it may be the case that the control mechanism cannot distinguish between copies of the service instance that have the same HA state. That is, all of the active service unit assignments need to handle the same version of the service instance (i.e., the new or updated SI′), while all of the quiescing service unit assignments handle a different version (i.e., the old SI). To be able to handle the new SI′, the active service units may need to be upgraded. An exemplary technique for managing this upgrade is illustrated in the flowchart of FIG. 7. Therein, at step 700, half of the active service units are shut down which results in quiescing their services. At step 702, which is optional, the number of service assignments can be changed from N to N′ (N<N′). This allows additional active assignments for the service instance to compensate for the quiescing units in the other half of the set. As the quiescing units reach the quiesced state they become locked and can be upgraded at step 704. When all of the quiesced service units have been upgraded, then the remaining units can be shut down at step 706. At step 708, the new SI′ service instance is configured. The upgraded service units are unlocked and assigned to the service instance SI′. They then start to serve new service requests while ongoing requests go to the quiescing units that still have the SI assignment. At step 710, as the quiescing units reach the quiesced state, they become locked and can be upgraded. Once upgraded, these service units can be unlocked and assigned the active role for SI′. If the number of assignments was increased at optional step 702, then that number can be reduced back to N at step 712.

According to still other exemplary embodiments, the control mechanism has the capability to distinguish between copies of the service instance that have the same HA state, e.g., using the version entry in list or table 70. That is, some of the active service unit assignments may handle one version of the service instance (the new SI′), while others continue to handle the other version (the old SI). According to this exemplary embodiment, all quiescing service unit assignments handle the old SI version. An exemplary method for performing an upgrade of an HA application under these conditions is shown in FIG. 8. Therein, at step 800, the new SI′ service instance is configured. The number of active service unit assignments can, optionally, be changed from N to N′ (N<N′) at step 802. This allows additional active assignments for the service instance to compensate for the quiescing ones. At step 804, M service units selected from those that still have the old SI assignment are shut down. This will put the selected service units into the quiescing state, which means that they will continue to process previously received requests for service until those requests are process, but will not take any new requests for service which will be rerouted. As the quiescing units reach the quiesced state they become locked at step 806 and can be upgraded as necessary. After all of the quiescing units became locked and were upgraded, then they can be unlocked at step 808, this assigns those units active roles with the new SI′. If there is still an active service unit with the old SI assignment, the process can be repeated from step 804 as necessary. If the number of active assignments was increased in step 802, then that number can be returned to the original number N of active assignments at step 810.

### Application Level Mapping

Consider now routing of service requests performed at the application level rather than the system level. As compared to the system level solutions described above, wherein a primary consideration is to distinguish the different versions of the service, the application level approach needs to handle the two distinguished services as a unity.

As mentioned earlier in this solution it is the structure of the application that provides the capability for a seamless upgrade. Namely, if service SI′ needs to be upgraded to SI″, both of which are visible as SI from a user's perspective, a dependency can be defined, i.e., that SI depends on the union of SI′ and SI″. Thus, at the beginning of an upgrade process, SI″ is not provided therefore (SI′ U SI″)=SI′. The service units providing SI″ are introduced either by adding new service units or by upgrading those providing SI′. SI′ is shut down with redirection of the requests that would be dropped to SI″. This means that the service units providing the service version SI′ become quiescing and will not serve new requests but only complete ongoing requests. Normally quiescing means dropping new requests, however this is modified according to these exemplary embodiments and the requests are redirected to the new units serving SI″. Once SI′ becomes locked, SI″ has taken over completely, i.e. (SI′ U SI″)=SI″. Therefore SI′ can be removed from the system. SI becomes completely dependant on SI″.

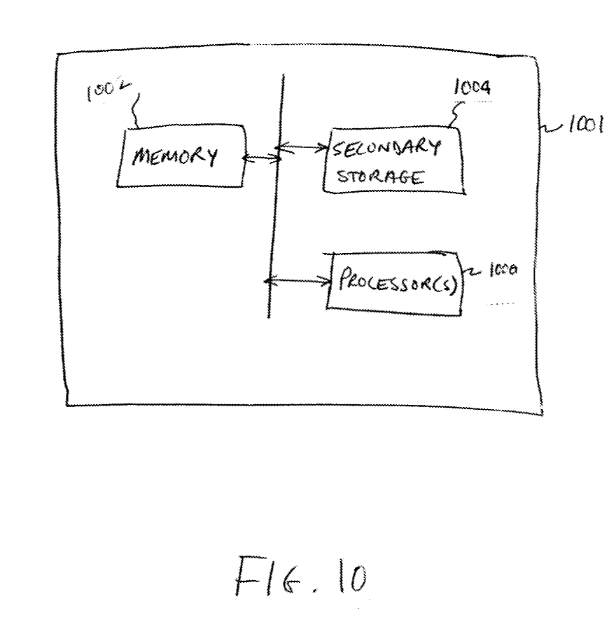

These service instances may be protected by their own groups of service units or by the same set of service units as shown in FIGS. 9(a) and 9(b), respectively. For example, in FIG. 9(a) a request for service SI may be handled as version SI′ within the group of service units 900 or as version SI″ within the group of service units 902. Alternatively, as shown in FIG. 9(b), a request for service SI can be handled using either version of the service within the same group of service units 904. Those skilled in the art will appreciate that the service unit groupings illustrated in FIGS. 9(a) and 9(b) are purely illustrative and that other groupings are possible.

There are various considerations for performing application level routing of service requests during service upgrades according to these exemplary embodiments. For example, depending on whether SI′ and SI″ can be collocated, i.e. served by the same service units or not, the resource usage may increase during the upgrade. When they cannot be served by the same units, SI″ is introduced by introduction of new service units. This should be significant only for resources that are required regardless of the load as the load of SI will be shared between SI′ and SI″, therefore the load dependent resource usage will be similarly distributed between the two. Once the upgrade is completed SI′ does not need to be provided any more and can be removed. Even if the two service versions SI′ and SI″ can be provided by the same service units, they may or may not be able to be assigned at the same time to a given service unit, which impacts whether the units must be upgraded before the new service assignments can be made. One solution is to introduce new service units, however it is also possible that through locking some service units are freed for the upgrade and after the upgrade these service units are assigned to the new service instance. Essentially this becomes a similar issue to that discussed above for the system level solution, however since the services are distinguished at the application level they are distinguished at the system level as well and therefore they can have their own protection fully deployed.

Considering now the interactions between the application level and the system level for those exemplary embodiments wherein the mapping is performed at the application level, the application will primarily need signaling from the system of the different stages of the service upgrade. The system, e.g., AMF entity 34, also provides the resources required for rerouting—this however may be provided by the application as well. The system should signal to the application when the new service becomes available. This is the moment when the old service needs to be shut down and the requests need to be rerouted. If the system provides the resources for rerouting, it can inform the application about those resources. Once the old service finished serving ongoing requests and all incoming requests are forwarded: the system needs to be notified to switch over SI directly to the new service and remove the old service.

Referring to FIG. 10, systems and methods for processing data according to exemplary embodiments of the present invention can be performed by one or more processors 1000, e.g., part of a server 1001, executing sequences of instructions contained in a memory device 1002. Such instructions may be read into the memory device 1002 from other computer-readable mediums such as secondary data storage device(s) 1004. Execution of the sequences of instructions contained in the memory device 1002 causes the processor 1000 to operate, for example, as described above. In alternative embodiments, hard-wire circuitry may be used in place of or in combination with software instructions to implement the present invention.

The foregoing description of exemplary embodiments of the present invention provides illustration and description, but it is not intended to be exhaustive or to limit the invention to the precise form disclosed. For example, the information used to perform rerouting of service requests as described above can be obtained from the AIS IMM (Information Model Management) service which maintains this information for the AMF entity 34 and may or may not be formatted as a list or table. The AMF entity 34 may also have a copy of this information stored internally. Modifications and variations are possible in light of the above teachings or may be acquired from practice of the invention. The following claims and their equivalents define the scope of the invention.

1. A method for upgrading a service and providing continuity to ongoing requests for said service while performing said upgrade, comprising:
supporting a service, wherein said service is logically independent of one or more processing entities which support said service;
further wherein an identifier is used to request said service, said identifier being independent of a feature set associated with said service;
upgrading said service to modify a first feature set to a second feature set different from said first feature set;
receiving a request for said service including said identifier;
routing said request either to a first processing entity which supports said service with said first set of features, or to a second processing entity which supports said service with said second set of features different than said first set of features; and
terminating said first processing entity's support of said service.

2. The method of claim 1, wherein said first processing entity is a server having an instance of a software application running thereon which supports said service with said first set of features and said second processing entity is said same server having another instance of said software application running thereon which supports said service with said second set of features.

3. The method of claim 1, wherein said first processing entity is a server having an instance of a software application running thereon which supports said service with said first set of features and said second processing entity is a different server having another instance of said software application running thereon which supports said service with said second set of features.

4. The method of claim 1, wherein said step of routing said request to either said first processing entity or said second processing entity is performed at an application level.

5. The method of claim 1, wherein said step of routing said request to either said first processing entity or said second processing entity is performed at a system level.

6. The method of claim 5, wherein said step of routing said request is performed, at least in part, by an availability management function (AMF) entity associated with said service.

7. The method of claim 6, wherein said first processing entity is associated with a first service instance managed by said AMF entity and said second processing entity is associated with a second service instance managed by said AMF entity and further wherein
said AMF entity maintains a list of said service instances and corresponding information associated with features associated with said service instances and uses said list to perform said routing of said requests.

8. The method of claim 1, wherein said step of receiving a request for said service includes only said identifier and does not include a feature set or other parameters associated with said service.

9. A platform for supporting a service comprising:
a first processing entity for supporting said service with a first set of features,
a second processing entity which supports said service which has been upgraded to a second set of features different than said first set of features, and
a routing mechanism for routing a request for said service to either said first processing entity or said second processing entity depending upon when said request is received,
wherein said service is logically independent of said first and second processing entities, and
further wherein said request is independent of said first and second sets of features.

10. The platform of claim 9, wherein said first processing entity is a server having an instance of a software application running thereon which supports said service with said first set of features and said second processing entity is said same server having another instance of said software application running thereon which supports said service with said second set of features.

11. The platform of claim 9, wherein said first processing entity is a server having an instance of a software application running thereon which supports said service with said first set of features and said second processing entity is a different server having another instance of said software application running thereon which supports said service with said second set of features.

12. The platform of claim 9, wherein said step of routing said request to either said first processing entity or said second processing entity is performed at an application level.

13. The platform of claim 1, wherein said routing mechanism operates at a system level.

14. The platform of claim 13, wherein said routing mechanism includes an availability management function (AMF) entity associated with said service.

15. The platform of claim 14, wherein said first processing entity is associated with a first service instance managed by said AMF entity and said second processing entity is associated with a second service instance managed by said AMF entity and further wherein
said AMF entity maintains a list of said service instances and corresponding information associated with features associated with said service instances and uses said list to perform said routing of said requests.

16. The platform of claim 9, wherein said request for said service includes only said identifier and does not include a feature set or other parameters associated with said service.

17. A computer-readable medium containing instructions which, when executed on a computer, perform the steps of:
supporting a service, wherein said service is logically independent of one or more processing entities which support said service;
further wherein an identifier is used to request said service, said identifier being independent of a feature set associated with said service;
upgrading said service to modify a first feature set to a second feature set different from said first feature set;
receiving a request for said service including said identifier;
routing said request either to a first processing entity which supports said service with said first set of features, or to a second processing entity which supports said service with said second set of features different than said first set of features; and
terminating said first processing entity's support of said service.

18. The computer-readable medium of claim 17, wherein said step of routing said request to either said first processing entity or said second processing entity is performed at an application level.

19. The computer-readable medium of claim 17, wherein said step of routing said request to either said first processing entity or said second processing entity is performed at a system level.

20. The computer-readable medium of claim 19, wherein said step of routing said request is performed, at least in part, by an availability management function (AMF) entity associated with said service.
